(19) United States
(12) Patent Application Publication
(10) Pub. No.: US 2004/0041524 A1
(43) Pub. Date: Mar. 4, 2004

(54) Fluorescent lamp circuit

(76) Inventor: Maurizio Menna, Wurzburg (DE)

Correspondence Address: McGlew & Tuttle, Scarborough Station, Scaboborough, NY, 10510-0827, US

(21) Appl. No.: 10/333,768

(22) PCT Filed: May 23, 2002
(86) PCT No.: PCT/DE02/01876

(30) Foreign Application Priority Data
May 23, 2001 (DE) 101 25 510.1

(51) Int. Cl. H05B 39/00

(52) U.S. Cl. 315/105; 315/291

(57) ABSTRACT

The invention relates to a method for operating fluorescent lamps (1, 16, 25, 36, 47, 52, 53, 74, 82), in particular for prolonging the service life of fluorescent lamps, wherein the load of at least parts of at least one electrode device (2, 3, 17, 18, 32, 33, 37, 38, 48, 49, 71, 72, 75, 90) of at least one fluorescent lamp is reduced by applying an electrical current, in particular a heating current (I), by means of a reduction in the load over time, and/or a reduction in the electrical power.

The invention relates to a method for operating fluorescent lamps, in particular for prolonging the service life of fluorescent lamps; the use of the method, as well as a fluorescent lamp circuit for operating fluorescent lamps, which circuit is suitable to advantageous implementation of the method.

Nowadays, a multitude of designs of fluorescent lamps are used for lighting purposes, because they are characterized by a long service life and great efficiency. Furthermore, due to their great efficiency, fluorescent lamps heat up only slightly, a characteristic which is advantageous in many applications, and even mandatory in some other applications of fluorescent lamps.

Various shapes and sizes of fluorescent lamps are produced. Elongated bar-shaped fluorescent lamps (colloquially known as “neon tubes”) continue to be in very widespread use; they are sold in various standard lengths and power ratings. A further design comprises curved fluorescent lamps where the illuminated tube is ring-shaped. Furthermore, over the last few years so-called power-saving lamps have become established, i.e. fluorescent lamps which are characterized by their particularly compact design, which fluorescent lamps feature a standardized screw cap so that they can be screwed into the usual light bulb sockets (e.g. E14 or E27). In addition, the screw cap comprises the components necessary for ignition and operation of the fluorescent lamps. The dimensions of these so-called power-saving lamps have been selected so that they correspond approximately to the dimensions of conventional (incandescent) light bulbs which have a filament.

Irrespective of the shape of the fluorescent lamp, the design principle is basically the same: a glass body contains a gas, usually mercury vapour, at very low pressure. In the gas, free electrons are accelerated in an electrical field. In a collision with a mercury atom, the accelerated electrons beat electrons out of the electron shell of said mercury atom. If the mercury ion which has formed in this way catches an electron, or if the electrons move up from an outer to an inner path, then light energy is released. In the case of mercury, such light energy is predominantly released in the form of UV radiation, so that, by means of a luminescent substance applied to the interior of the glass body of the fluorescent lamp, the UV radiation is transformed into visible light. The electrical field necessary to accelerate the free electrons is generated by applying mains voltage (typically 110 V/60 Hz or 230 V/50 Hz alternating voltage) to the electrodes which are located at both ends of the fluorescent lamp. It is by way of the electrodes that the required number of free electrons is placed into the gas which is contained in the fluorescent lamp. This requires the electrodes to be made of a material which has a relatively low work function for electrons. In addition to the electrical field applied, the electrodes must be of a certain temperature so that a sufficient number of electrons emanate from the electrodes.

In a fluorescent lamp which is operative, the temperature which is required for adequate emission of electrons is maintained by dissipation heat on the electrodes.

Special techniques are required to initially ignite the gas discharge in a fluorescent lamp after switching on the fluorescent lamp. Usually, the temperature of the electrodes is increased to this effect, so that a larger number of electrons can emanate. To this effect, the electrodes of the fluorescent lamp are electrically heated. Usually, the electrodes are formed at both sides of the fluorescent lamp in the form of a heating filament. In each case, the two ends of the heating filament are connected to a connection contact which is situated on the outside of the fluorescent lamp. Thus, the electrodes of the fluorescent lamp are heated by the application of an electrical heating voltage to the two contacts which are usually situated at each end of a fluorescent lamp.

Furthermore, an increased voltage must be applied to the electrodes of the fluorescent lamp in order to start the gas discharge. This happens for example by means of a coil which is looped into the heating current circuit. A so-called quick-starter, which also forms part of the heating current circuit, abruptly interrupts the heating current flowing through the electric circuit. In this way, by self-induction of the coil, the quick-starter thus generates a correspondingly increased voltage on the electrodes of the fluorescent lamp.

Immediately after the fluorescent lamp is switched on, thus first of all the electrodes situated at both ends of the fluorescent lamp are heated up. After a certain time the current is abruptly interrupted by the quick-starter, as a result of which, by means of the coil, the ignition voltage necessary to ignite the gas discharge is applied to the two electrodes. During operation, there is now only a low voltage applied between the electrodes of the fluorescent lamp, because the ignited gas discharge practically has the effect of a short circuit.

Over time, the loads which occur during the switch-on procedure of the electrodes result in one of the heating filaments eventually burning out. Consequently, the electrodes of the fluorescent lamp can no longer be heated and the fluorescent lamp can no longer be ignited. This is often the reason for a defect in the fluorescent lamp. The fluorescent lamp must be changed, although the gas mixture of the fluorescent lamp continues to be fully functional.

This frequently occurring defect in fluorescent lamps results in the fluorescent lamp having to be replaced which causes a corresponding effort and corresponding expense. At the same time, there is a large quantity of hazardous waste, as the mercury which is usually contained in fluorescent lamps is very problematic from the point of view of the environment.

There is a further common defect in lights which comprise fluorescent lamps, in that the quick-starter becomes defective. Frequently, the contacts of a glow discharge lamp igniter weld together, so that said glow discharge lamp igniter can no longer interrupt the heating current which flows through the electric circuit. On the one hand, it is thus impossible to ignite the fluorescent lamp; on the other hand, the electrodes of the fluorescent lamp are permanently exposed to a heating current which causes considerably increased wear to said electrodes. This problem can only be solved by changing the quick-starter. Often, several days pass until the defect is detected and the quick-starter is subsequently exchanged; with the fluorescent lamp being subject to increased wear during this period.

It is thus the object of the invention to propose a method for operating fluorescent lamps as well as a circuit for operating fluorescent lamps, with which method or circuit fluorescent lamps can be operated in such a way that their expected service life is prolonged.

This object is met by a method according to claim 1 and a fluorescent lamp circuit according to claim 10.

In the proposed method for operating fluorescent lamps, in particular for prolonging the service life of fluorescent lamps, this object is met in that the load of at least parts of at least one electrode device of at least one fluorescent lamp is reduced by applying an electrical current, in particular a heating current (I), by means of a reduction in the load over time, a reduction in the electrical power or both of these. The term “reduction in the load over time” does not necessarily relate to an individual ignition process, but instead, it should be understood in a wider sense. Thus for example a method in which alternately only a part of the electrode devices provided in a fluorescent lamp (individual heating filaments or thermionic cathodes) are heated at a given time, also falls within the meaning of reduction in the load over time, namely across several switch-on cycles. Similarly, a method in which there is a reduction in the number of the heating cycles carried out per unit of time (for example of the heating cycles per week or per month) also falls within the meaning of reduction in the load over time, namely as a reduced load averaged over a period of time. The same of course also applies to cases where a fluorescent lamp circuit comprises a multitude of fluorescent lamps and the reduction in the load of the electrodes or electrode components is provided in at least a part of the fluorescent lamps.

Similarly, the term “reduction in the electrical power” should be understood in a wider context. In particular, this can be achieved by a reduction in the current intensity or the current voltage which is applied to the individual electrode device. This applies particularly, but not exclusively, to the electrical power which is applied to the electrode devices for heating up said electrode devices. However, it is also possible to provide reduced electrical power during operation of the fluorescent lamp, thus prolonging the service life of the fluorescent lamp. If necessary, the reduction in the electrical power can be compensated for. In the case of a reduction in heating power, this can, for example, take place by supplying additional thermal energy which is supplied by an additional heating device situated outside the fluorescent lamp.

In any case, the proposed method results in a reduction in the load of the electrode devices of the fluorescent lamp, thus leading to the achievement of a longer service life of the electrode devices. Since normally the service life of a fluorescent lamp is limited by the burning out of a coiled filament, the proposed method generally also achieves a longer service life of the fluorescent lamp itself. It is of course also possible to achieve both a reduction in the load over time, and a reduction in the electrical power in combination. This can lead to a still longer service life of the fluorescent lamp.

The method provides a particular advantage in that it can be used together with the known standardized fluorescent lamps, plug-and-socket connectors, components and light-fitting housings. This makes possible a particularly cost-effective changeover to the proposed method.

An advantageous option of implementing the method proposes that a heating current is applied in at least one fluorescent lamp at most at one end of the fluorescent lamp to at least parts of the electrode device located there. Thus during the ignition procedure in at least one fluorescent lamp at most one electrode device or only parts of this electrode device are exposed to a load by the application of a heating current, while the respective other electrode or both electrodes are essentially not under load. If the electrode devices or parts of the electrode devices to which a heating current is applied are alternated by switch-technology means, a significant prolongation of the service life can be achieved. If, for example, with every switch-on procedure, the end of the fluorescent lamp at which a heating current is applied to the electrode devices is changed, then essentially a doubling of the service life of the fluorescent lamp can be achieved. It is also possible that such a change is carried out manually, for example in that the alignment of the fluorescent lamp in the socket is changed by turning the fluorescent lamp around.

If only one electrode device is heated, with the method explained, the fluorescent lamp is operated in a “direct current mode” immediately after ignition. This means that the majority of electrons only emanate from the heated electrode. However, during extended operation of the fluorescent lamp the non-heated electrode can heat up as a result of dissipation heat, to the extent that after an initial period of being switched on, the fluorescent lamp works in normal “alternating current mode”.

Apart from some exceptions, the above-mentioned control of the electrode device is also possible if one heating filament of an electrode device has already burnt out or has a contact defect. This makes it possible that fluorescent lamps which can no longer be operated with known fluorescent lamp circuits can continue to be operated by means of the proposed method.

In an advantageous improvement of the method, the power of the heating current of at least a part of at least one electrode device of at least one fluorescent lamp is at least reduced after a period of time, in particular when an ignition device is defective. In a number of known fluorescent lamp circuits, in particular in circuits where glow discharge lamps with a bimetal electrode are used as quick-starters, it is possible that ignition of the fluorescent lamp occurs only after an extended period of time or not at all. This can be due to a defect or due to wear of the quick-starter or other components. Above all in quick-starters of the glow discharge lamp design, during such delayed ignition of the fluorescent lamp, a heating current essentially at full power flows for a long time through the electrode devices of the fluorescent lamp, so that said electrode devices are subjected to very considerable wear. This shortens the service life of the fluorescent lamp accordingly. In other words, the electrode devices are subjected to an unnecessary load over time. In contrast, in the proposed improvement of the method, after some time the heating current is automatically reduced or switched off altogether. There is thus no load or only a slight load on the electrode device between the time when a defect occurs and the time said defect is repaired. After the repair, a heating current at full power is applied again to the electrode devices. Preferably, this occurs automatically. However, it is also possible that the user has to activate a switching device so that a heating current at full load is again applied to the electrode devices, in particular without having to wait for components to cool down.

It is also possible for ignition or operation of at least one fluorescent lamp to take place at a voltage, at the electrode devices of the fluorescent lamp, which voltage is increased when compared with the supply voltage of the fluorescent lamp circuit. Of course, both ignition and operation at an increased voltage are possible. If the voltage is increased accordingly, it is possible for the electrical power applied for heating the electrode devices to be reduced again. This results in a renewed reduction in wear of the electrode devices and thus in an additional prolongation of the service life of the fluorescent lamp. In extreme cases it is even possible to completely do without applying a heating current to the electrode devices. Consequently, it is in particular possible to use as lighting means even those fluorescent lamps where the electrode devices at both ends of the fluorescent lamp are defective, for example, because the heating filaments of the electrode devices have burnt out. The usual supply voltage of the fluorescent lamp circuit is in line with the usual mains voltages of 230 V/50 Hz and 110 V/60 Hz respectively. However, other on-board electrical system voltages of motor vehicles, such as the usual 12 V (passenger motor vehicles) or 24 V (utility vehicles) are also imaginable.

Preferably, the voltage at the electrode devices of at least one fluorescent tube during ignition, during operation, or during ignition and operation, is at least 400 V, preferably however at least 600 V. Such voltages can ensure particularly fast and low-wear ignition or low-wear operation of the fluorescent lamp. In principle, there is no upper limit to the voltage. However, as a rule, increased voltage requires additional or more expensive assemblies, and at particularly high voltages insulation problems occur. Consequently, the voltage selected for ignition and/or operation of the fluorescent lamp should not be too high.

It can also be advantageous if at least one fluorescent lamp is operated at a power which is reduced when compared with the rated power of the fluorescent lamp. Due to the associated lower load on the electrode device, in this way too, prolongation of the service life of the fluorescent lamp can be achieved. Besides, it is thus immaterial whether the fluorescent lamp is operated at constant reduced power or whether the power of the fluorescent lamp is flexibly varied depending on the requirements.

In a further possible improvement of the proposed method, at least one fluorescent lamp is essentially operated in continuous operation, wherein there is alteration at least between a dimmed position with reduced power of the fluorescent lamp, and a bright position, in particular a position with essentially full power of the fluorescent lamp. In this type of activation the load on the electrode device is reduced in that the number of start procedures per unit of time (for example per week or per month) is reduced. The proposed method is particularly appropriate in cases where “residual light” is desired. For example, the method could particularly advantageously be used in stairwells or corridors in order to reduce the risk of accidents when the light is switched off abruptly by an automatic timer. While in normal illumination methods the light is switched off altogether, in the proposed method there is only a considerable reduction in brightness. In this way, the way to the next light switch is at least faintly illuminated so that a clear reduction in the danger of tripping over can be achieved. It is thus not only possible to achieve an extended service life of the fluorescent lamp, but also particularly safe operation. The bright position can be the rated power of the fluorescent lamp or an electrical power which is reduced in comparison with the rated power of the fluorescent lamp.

Advantageously, the power of the fluorescent lamp in the dimmed position is 0.1% to 20% of the power in the bright position. In this range, it is possible to ensure adequate heating up of the electrode devices in the dimmed position, while at the same time the electrical power is reduced to such an extent that the energy consumption in the dimmed position (in standby mode) is relatively low.

Preferably, reduction in the power of at least one fluorescent lamp is by passive, essentially non-dissipative components, such as in particular controllable capacitors and controllable coils.

In this way a particularly simple and economical design of the circuit arrangement for controlling the fluorescent lamp can be realized. At the same time, the design has particular advantages in that essentially no active electrical power (by ohmic resistance) is converted. This results both in lower power consumption and in negligible heating up of the components. If the components are designed to be controllable, a dimmer can be replaced by said components. Furthermore, the above-mentioned passive components have an advantage when compared with conventional dimmers for fluorescent lamps in that they do not require any radio interference suppression. Quite the opposite, any danger of radio interference is eliminated right from the start.

A further option of advantageously implementing the method is provided in that in at least one fluorescent lamp additional application of heat to at least a part of at least one electrode device takes place. In other words, heat generation is handled by a heat-generating device which is independent of the electrode device. This makes it possible for the heating power which is to be generated by a single heat-generating device to be lower. It also makes possible a redundant design in which heat-generating devices can fail without there being a danger of failing to provide the necessary heating power. In any case, a longer service life of the fluorescent lamp can be achieved. In extreme cases the electrode device can also be heated to the required temperature without the electrode device itself having to produce a heating effort.

It is particularly advantageous if the additional application of heat takes place by way of a component which is independent of the fluorescent lamp. In this case, the defective heat-generating component can be changed independently of the fluorescent lamp. This makes possible cost-effective continued operation while at the same time reducing the volume of waste. In particular, it is not necessary to dispose of the mercury contained in the fluorescent lamp, a hazardous waste which is problematic from an environmental point of view.

It has been shown to be particularly advantageous if the additional application of heat takes place immediately before the ignition procedure, during the ignition procedure, or immediately before and during the ignition procedure of the fluorescent lamp or fluorescent lamps. In this case, the heat load on the electrode devices can be reduced. At the same time, the energy requirement of the lamp is reduced because the additional application of heat only takes place so as to be timed in the context of ignition of the fluorescent lamp, but no longer takes place after the fluorescent lamp has ignited and thus the additional application of heat is no longer required. However, it is also possible to carry out the additional application of heat during operation of the fluorescent lamp. The latter can for example be advantageous in the case of fluorescent lamps located out of doors, when the outdoor temperatures are particularly low. Furthermore, it would also be imaginable to make any additional application of heat dependent on the ambient temperature. This can for example take place by way of temperature sensors or by a simple PTC (positive temperature coefficient) resistor.

It is also particularly advantageous if status information about the operational state of the fluorescent lamp circuit, in particular status information about defects that occur, is issued. By means of such status information, even a layperson can be informed about the presence of a defect. The display can also provide information about whether an expert needs to be called for repair work or whether some action from a lay person is to be carried out, such as for example changing a fluorescent lamp or changing a starter cartridge. However, it is also possible for the status information to include more detailed information which provides the expert who is to carry out the repair work with clues about the cause of the problem, so that said expert can carry out the repair more quickly.

It is advantageous if the status information is issued visually, in particular by means of light emission. This makes it possible to simply read the information without the need for measuring instruments or other output devices having to be connected to the respective device. Light signals also have the advantage that while they are sufficiently noticeable, they are not excessively intrusive over a longer period of time, as would be the case, for example, with an acoustic signal.

A further advantageous option of implementing the method consists of several fluorescent lamps being connected in series, wherein in the series connection comprising fluorescent lamps, heating current is applied only to a part of the electrode devices of the fluorescent lamps, in particular only to the two outermost electrode devices of the series connection. Since a heating current needs to be applied only to part of the electrode devices, as already described, the average wear of the electrode devices is reduced, so that an altogether prolonged service life of the arrangement can be achieved. This method is particularly advantageous if two fluorescent lamps are connected in series. This method has a particular advantage in that it can be used in the context of already existing fluorescent lamp circuits. If, for example, in a fluorescent lamp circuit for controlling a 1,200 mm fluorescent lamp, instead of the 1,200 mm fluorescent lamp two fluorescent lamps of 600 mm length each, connected in series, are used and if the outside electrodes of the fluorescent lamps are controlled in the same way as the electrodes of the 1,200 mm fluorescent lamp, then the fluorescent lamp circuit can continue to be used without any other modifications. This ensures particularly cost-effective retrofitting to a design according to one of the embodiments of the present invention.

The method according to one of claims 1 to 15, in particular the method according to one of claims 2, 4, 5, 10, 11, 12 or 15 is particularly advantageous if applied in conjunction with fluorescent lamps in which at least parts of the electrode device at least at one end of the fluorescent lamp are defective. In normal light fittings, such fluorescent lamps can no longer be used, because due to a defect of even only a part of an electrode device of the fluorescent lamp there is no longer a closed heating current circuit. Consequently, the fluorescent lamp can no longer be ignited. Up to now, such fluorescent lamps were thrown away although in combination with the proposed method, or with one of the devices described below, it would be possible to still use them. Continued use results in significant cost savings and in a reduction in the quantity of hazardous waste generated. Of course it is also possible to operate fully functional fluorescent lamps with the proposed method. Here too, the proposed method provides several advantages.

A fluorescent lamp circuit for operating fluorescent lamps, in particular for the advantageous implementation of the above-mentioned method, is characterized in that the fluorescent lamp circuit comprises at least one current-limiting device which limits the electrical current, in particular a heating current, through at least parts of at least one electrode device of at least one fluorescent lamp, concerning the electrical power, the duration of time, or both of these. With such a current-limiting device it is possible to achieve a reduction in the load caused by the electrical current of the respective parts of the electrode device of at least one fluorescent lamp by a reduction in the load over time, a reduction in the electrical power, or in both of these. In this way, the already described advantages can be achieved. In particular, in a respective design of the fluorescent lamp circuit, conventional standard fluorescent lamps can be used. This makes possible a particularly simple and cost-effective changeover to the new technology.

It is advantageous if in the fluorescent lamp circuit at least one current-limiting device is designed as a continuous-current protective circuit, such that the heating current through at least parts of at least one electrode device of at least one fluorescent lamp after a period of time in particular during a defect in the ignition device of the fluorescent lamp, is at least reduced. With this improvement of the fluorescent lamp circuit, the advantages which have already been described in the context of the method can be achieved. If in this context, reference is made to a time period, this does not denote that the particular physical parameter concerned must always be the time. But rather, other basic parameters too are imaginable, which parameters can also correlate directly or indirectly with time, but they do not necessarily have to correlate. For example, a timer can be used which switches the heating current off after several minutes. The continuous-current protective circuit can however also comprise a light-sensitive element which is used to check whether or not the fluorescent lamp is lit.

A particularly simple embodiment of the current-limiting device can be achieved if the continuous-current protective circuit comprises at least one temperature-sensitive resistor device, in particular a temperature-sensitive resistor device whose electrical resistance increases as the temperature rises. Such a temperature-sensitive resistor device can register, for example as a sensor device, the heat which in the electrode device arises as a result of the heating filaments or as a result of dissipation heat. Such sensor information can be reprocessed in a correspondingly designed subassembly. However, it is also possible for the resistor device to reduce the heating current through the electrode device directly, as a current-limiting element. In particular, the temperature-sensitive resistor device can be designed as a so-called PTC (positive temperature coefficient) resistor, and can simply be looped into the heating current circuit. If the fluorescent lamp fails to ignite, then the heating current, which continues for the time being, causes heating up of the resistor device and consequently an increase in the electrical resistance and consequently a limitation of the current flowing in the heating current circuit.

It is also advantageous if the current-limiting device is designed as a bypass circuit, such that a heating current is applied to at least one fluorescent lamp at the most at one end at least to parts of the electrode device located there. If a heating current is applied to an electrode device at one end of a fluorescent lamp, with such a design of a fluorescent lamp circuit, the fluorescent lamp, at least during and immediately after ignition, is operated in a “direct current mode”, as has already been described. This fluorescent lamp circuit has a substantial advantage in that a large part of fluorescent lamps which up to now were considered to be defective can continue to be used.

The design can particularly easily be realized as a bypass circuit if said bypass circuit comprises an electrical connection of contacts of the electrode device, in particular a short circuit of the contacts, at one end of at least one fluorescent lamp. In this case, it does not matter whether or not the electrode device at the respective end of the fluorescent lamp is defective, in particular whether or not it is interrupted. The heating current circuit itself is not interrupted by the defect in the electrode device.

Furthermore, it is particularly advantageous if at least one bypass circuit is designed as an automatically detecting bypass circuit, such that the automatically detecting bypass circuit, during a defect of at least parts of the electrode device which is located at one end of the fluorescent lamp, automatically activates the electrode device at the corresponding end of the fluorescent lamp. In this case, it is not necessary for fluorescent lamps which have a defective electrode device at one side to be installed in a particular direction of alignment. In this way, increased user friendliness of the fluorescent lamp circuit can be achieved. The aforesaid improvement is also advantageous in cases where in a new fluorescent lamp, a heating filament burns out at one end after extensive operation. In this case, the automatically detecting bypass circuit changes the ends of the fluorescent lamp automatically if necessary, so that the fluorescent lamp can continue to be used without necessitating any action by the user.

In a further advantageous design of the current-limiting device, the current-limiting device is designed as a voltage booster device, such that the ignition procedure or the operation of at least one fluorescent lamp takes place at a voltage which is increased in comparison with the supply voltage of the fluorescent lamp circuit. Of course it is also possible for both the ignition procedure and the operation of the fluorescent lamp to take place at an electrical voltage which is increased when compared with the supply voltage of the fluorescent lamp circuit. As has already been mentioned in the context of the method proposed, if such a such a voltage booster device is present, it is also possible to achieve a reduction in wear of the electrode devices of fluorescent lamps. In extreme cases it is also possible to design the bypass circuit such that no heating current is applied to any of the electrode devices of a fluorescent lamp. It is thus also possible to use fluorescent lamps where the electrode devices at both ends of the fluorescent tube are defective. With such fluorescent tubes it is particularly sensible to control these fluorescent tubes at a power which is reduced when compared with the rated power of the fluorescent lamp, because such fluorescent lamps would otherwise only have a relatively short residual service life. However, if they are for example operated at a maximum power of 25% of the rated power, then even fluorescent lamps in which the electrode devices are defective at both ends can still be operated at a residual service life of up to several thousand hours. Irrespective of any defect which may be present in one or several electrode devices, if a voltage booster device is present, particularly fast ignition of the fluorescent lamp can be achieved. In this case the well-known repeated flickering until ignition of the fluorescent lamp takes place, which flickering is often considered to be irritating, does not occur.

If at least one voltage booster device comprises at least one voltage multiplier circuit, then a particularly simple design of the fluorescent lamp circuit becomes possible. If a known voltage multiplier cascade is used, then it is possible, with simple and economical components, namely essentially with an arrangement of diodes and capacitors, in a simple and cost-effective way to achieve voltage doubling, trebling, quadrupling etc. With a corresponding design of the voltage multiplier cascade it is thus possible even with simple means to achieve an adaptation of the fluorescent lamp circuit to various supply voltages, in particular to the normally used mains voltages of the power networks (for example 110 V/60 Hz in the USA and 230 V/50 Hz in Europe). Moreover, a voltage multiplier cascade can also be achieved by suitably wiring up a rectifier with capacitors.

It is also advantageous if in the fluorescent lamp circuit at least one current-limiting device comprises at least one additional heating device, which in at least one fluorescent lamp applies heat to at least parts of at least one electrode device. With such an additional heating device it is on the one hand possible to apply a lower heating current to the respective parts of the electrode devices. In particular in the case of fluorescent lamps which are to be installed out of doors, such as for example in the case of street lighting, such an additional heating device can above all be advantageous at particularly low ambient temperatures. Likewise, it is possible that the additional heating device or the additional heating devices can act so as to be redundant to the heating device of an electrode device. In this arrangement, the circuit can be designed such that a single remaining heating device can effect the heating of the electrode device, which heating is required for ignition of the fluorescent lamp. In any case, a significant prolongation of the service life of the fluorescent lamp can be achieved. It is particularly advantageous if such an additional heating device is provided in the case of curved fluorescent lamps in which the two electrode devices of a fluorescent lamp are adjacent to each other (for example in the case of annular fluorescent lamps or in the case of power-saving lamps). In this case, one single additional heating device can apply heat to several electrode devices.

In this arrangement it is particularly advantageous if in at least one fluorescent lamp at least parts of at least one additional heating device are designed so as to be independent of the fluorescent lamp. In the case of a defect in the additional heating device, said additional heating device can be exchanged as an individual component, without the need to replace the fluorescent lamp. In this way it is possible to keep repair costs low. Furthermore, the quantity of waste can be reduced.

It is advantageous if at least one additional heating device of at least one fluorescent lamp comprises a temperature-dependent resistor device, in particular a temperature-dependent resistor device whose electrical resistance increases as the temperature rises. With such a temperature-dependent resistor device the additional heating device can be brought to the required temperature particularly quickly. After the temperature has been reached, the heating current can be reduced by means of the temperature-dependent resistor device. In the simplest of cases the temperature-dependent resistor device itself can serve as an additional heating device. However, it is also imaginable that the temperature-dependent resistor device merely serves as a sensor. Finally, it is also possible to provide additional control elements and regulating elements which for example switch the additional heating device off after a particular period of time.

It is also sensible if at least parts of an additional heating device of at least one fluorescent lamp are connected in series to at least parts of at least one electrode device of at least one fluorescent lamp. In this case, if the heating current flowing through the additional heating device is reduced, the heating current flowing through the electrode device is automatically reduced as well. The same applies when the heating current which flows through the additional heating device or through the electrode device is switched off.

In this context the term “series connection” also includes an arrangement where the additional heating device is connected in parallel to other components, for example to a capacitor, and where this parallel arrangement is connected in series to at least parts of at least one electrode device. In this case too, at least a part of the heating current flows through the additional heating device so that the current flowing through the additional heating device is correlated with the heating current flowing through-the electrode device.

Furthermore, it is advantageous if at least one current-limiting device is designed as a power-limiting device, in particular as a controllable power-limiting device, such that at least one fluorescent lamp is operated at a power which is lower than the rated power of the fluorescent lamp. By reducing the maximum permissible power of at least one fluorescent lamp in relation to the rated power of the fluorescent lamp, the service life of the fluorescent lamp can be prolonged. As has already been explained, this applies in particular if one or several electrode devices are defective or show signs of wear. If a controllable power-limiting device is provided, then apart from its function as a wear-reducing device, it can additionally be used as a dimmer. To this effect a remote control option (which is not explained in detail in this document) can be provided so that the fluorescent lamp, as is the case with known dimmers, can be dimmed by means of a regulator which is remote from the lamp. In every case, in a corresponding embodiment, an altogether more simplified design can be achieved.

Preferably at least one power-limiting device essentially comprises passive, essentially non-dissipative components, such as in particular regulatable capacitors, regulatable coils, or a combination of regulatable capacitors and regulatable coils. Such an embodiment ensures a particularly simple design of the fluorescent lamp circuit. Since the components are essentially non-dissipative, i.e. they do not consume any active power (they have no ohmic resistance) it is furthermore possible to achieve low energy consumption. The design comprising passive components is in particular significantly simpler and more economical when compared with conventional dimmers for fluorescent lamps. In particular, no special measures for radio interference suppression are required, since it is not inevitable that high-frequency electrical currents occur.

If the fluorescent lamp circuit comprises at least one current-limiting device as a continuous operation device, such that at least one fluorescent lamp is essentially operated in continuous operation, wherein the fluorescent lamp alternates at least between a dimmed position with low power and a bright position, in particular a position with essentially full power, it is possible to achieve the advantages which have already been described in connection with the proposed method. The bright position can either essentially be the rated power of the respective fluorescent lamp or it can be the maximum permissible power of the fluorescent lamp, which power is reduced when compared with the rated power of the fluorescent lamp.

Analogous to the method described, it is advantageous if the continuous operation device is made such that the power of the fluorescent lamp in the dimmed position is 0.1% to 20% of the power in the bright position.

A further advantageous implementation option consists of at least one current-limiting device being designed as a series connection device, such that several fluorescent lamps are connected in series, wherein in the series connection comprising fluorescent lamps a heating current is applied only to a part of the electrode devices, in particular only to the two outermost electrode devices of the series connection. In this case the advantages which have already been described in connection with the method are obtained analogously.

It is also advantageous if the fluorescent lamp circuit comprises at least one monitoring device, such that the status of the fluorescent lamp circuit, and in particular a malfunction thereof, is displayed. Here too, the advantages already described in connection with the method apply analogously.

Preferably, the monitoring device is a visual device so that visual checking becomes possible. According to preference, the visual device can be self-illuminating or for example only reflective. For example, it might be a grid arrangement of visual elements, wherein the visual elements are visible from the outside by way of a suitable device either with a dark coated side or with a side coated in a bright color.

Preferably, however, the visual device is designed as a light emitting device, in particular as an incandescent lamp and/or a light emitting diode. Such a design is particularly cost-effective because the respective components can be obtained economically and accordingly can be controlled simply. Furthermore, light emitting devices are easily recognizable in the dark which is an advantage in particular in the proposed application since in the case of a defect of the fluorescent lamp circuit there may no longer be any light.

Below, several exemplary embodiments of the invention are explained with reference to the drawings provided.

The following are shown:

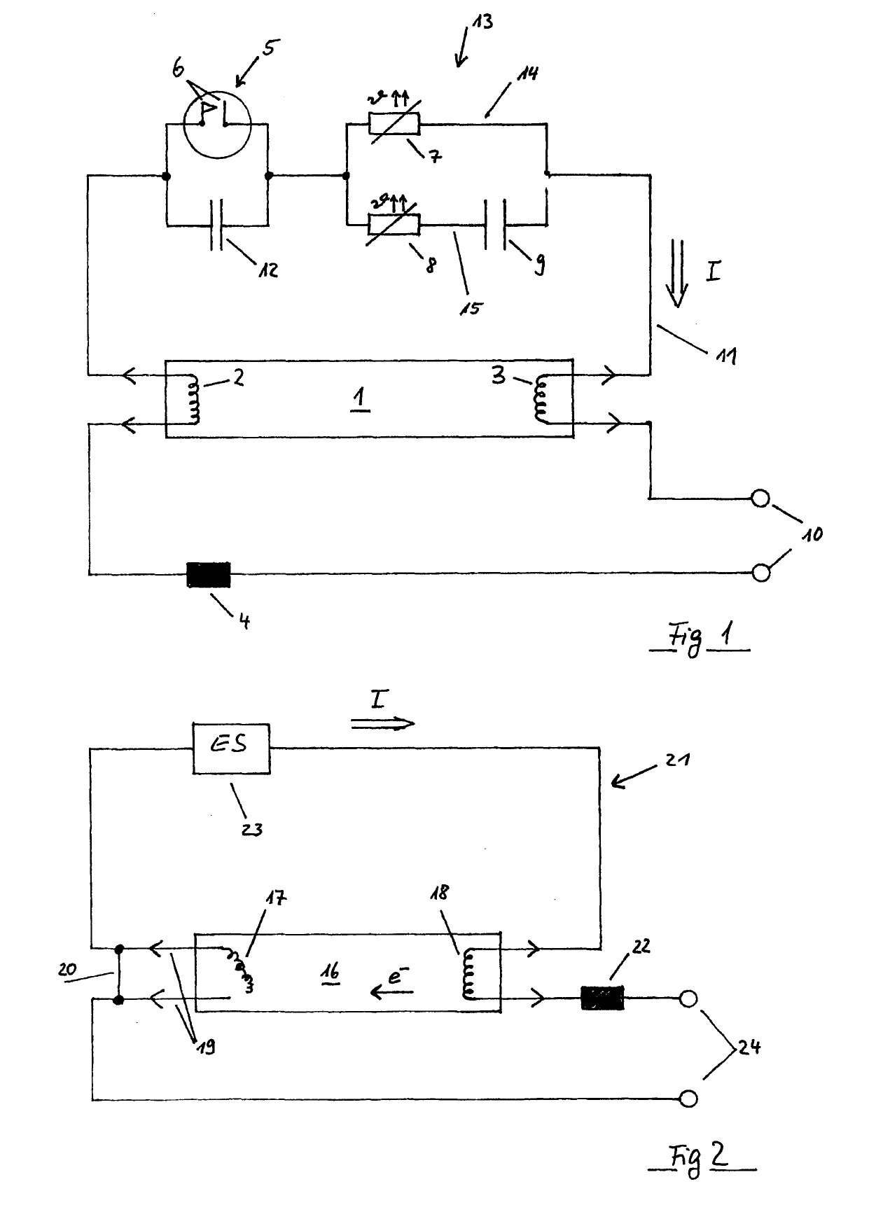

FIG. 1 a fluorescent lamp circuit comprising a continuous-current protective circuit;

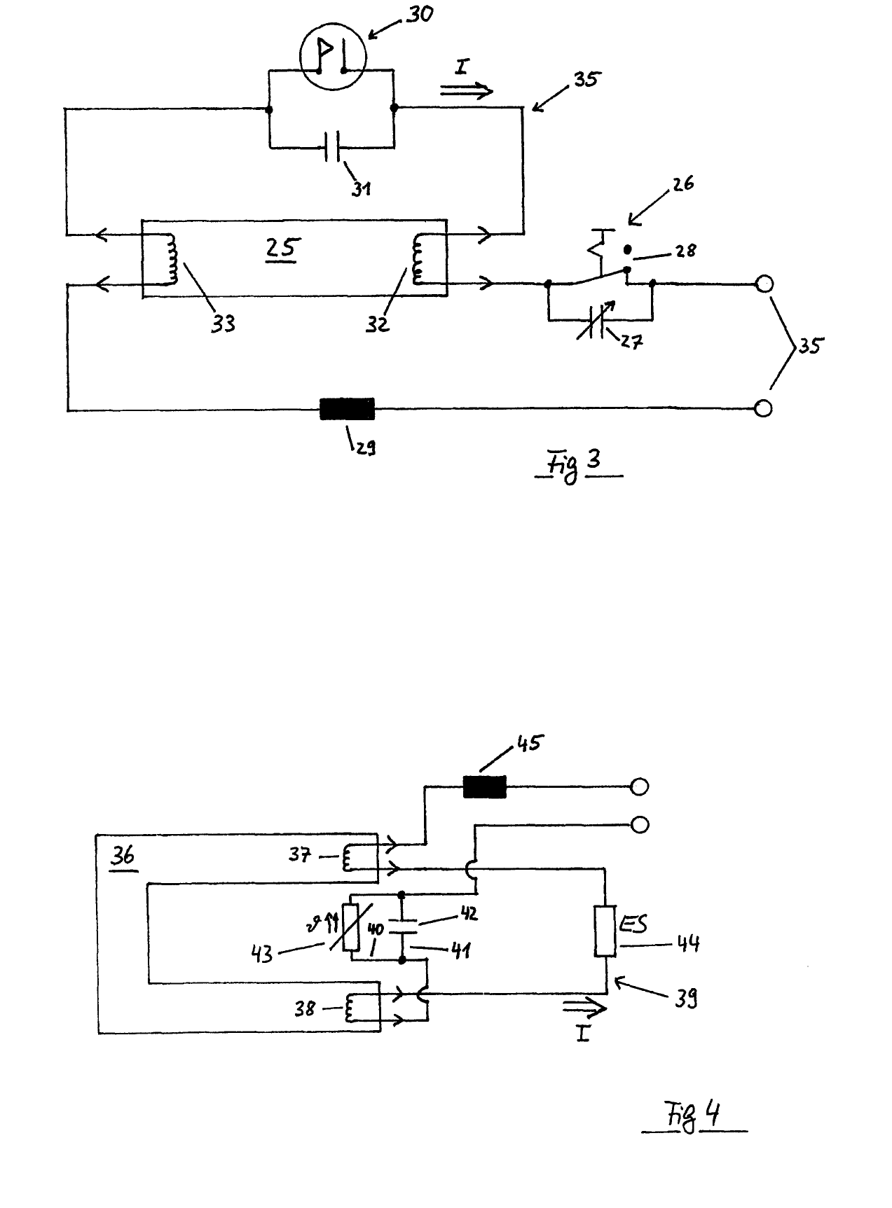

FIG. 2 a fluorescent lamp circuit comprising a bypass circuit;

FIG. 3 a fluorescent lamp circuit comprising a continuous operation device;

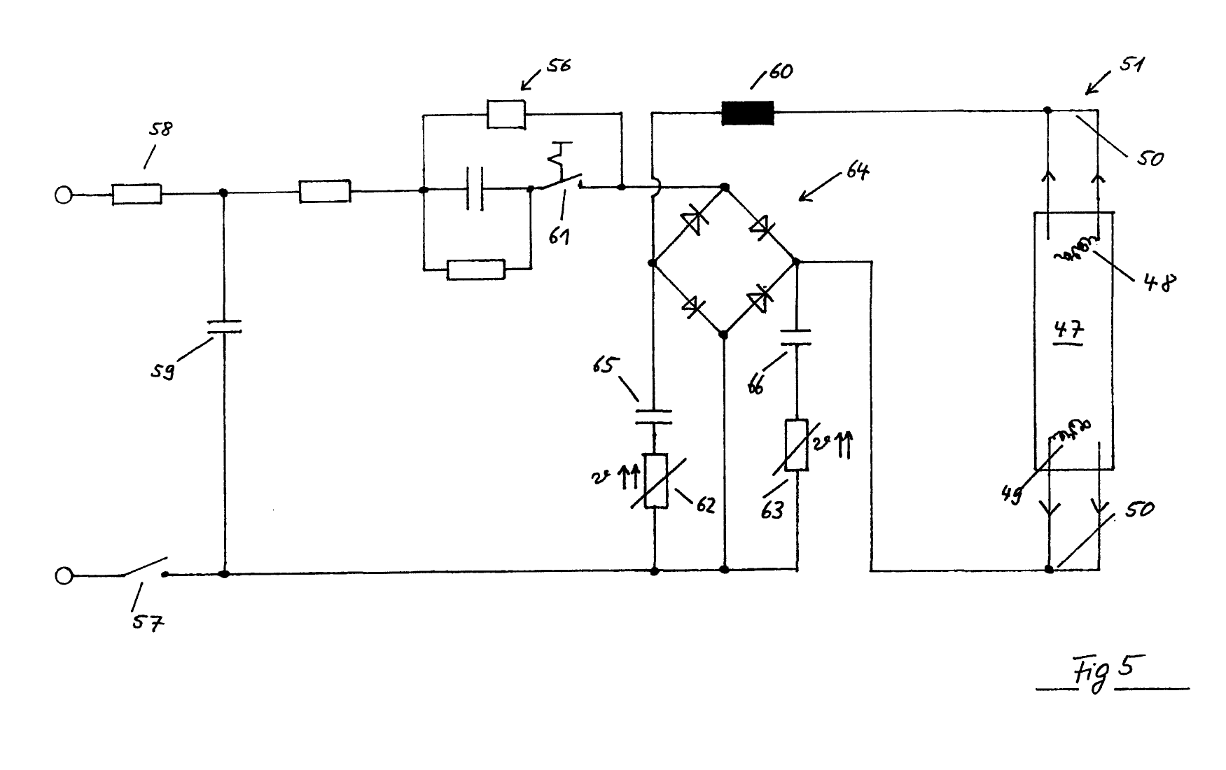

FIG. 4 a fluorescent lamp circuit comprising an additional heating device;

FIG. 5 a fluorescent lamp circuit comprising a combination of a continuous-current protective circuit, a voltage booster device as well as a continuous operation device;

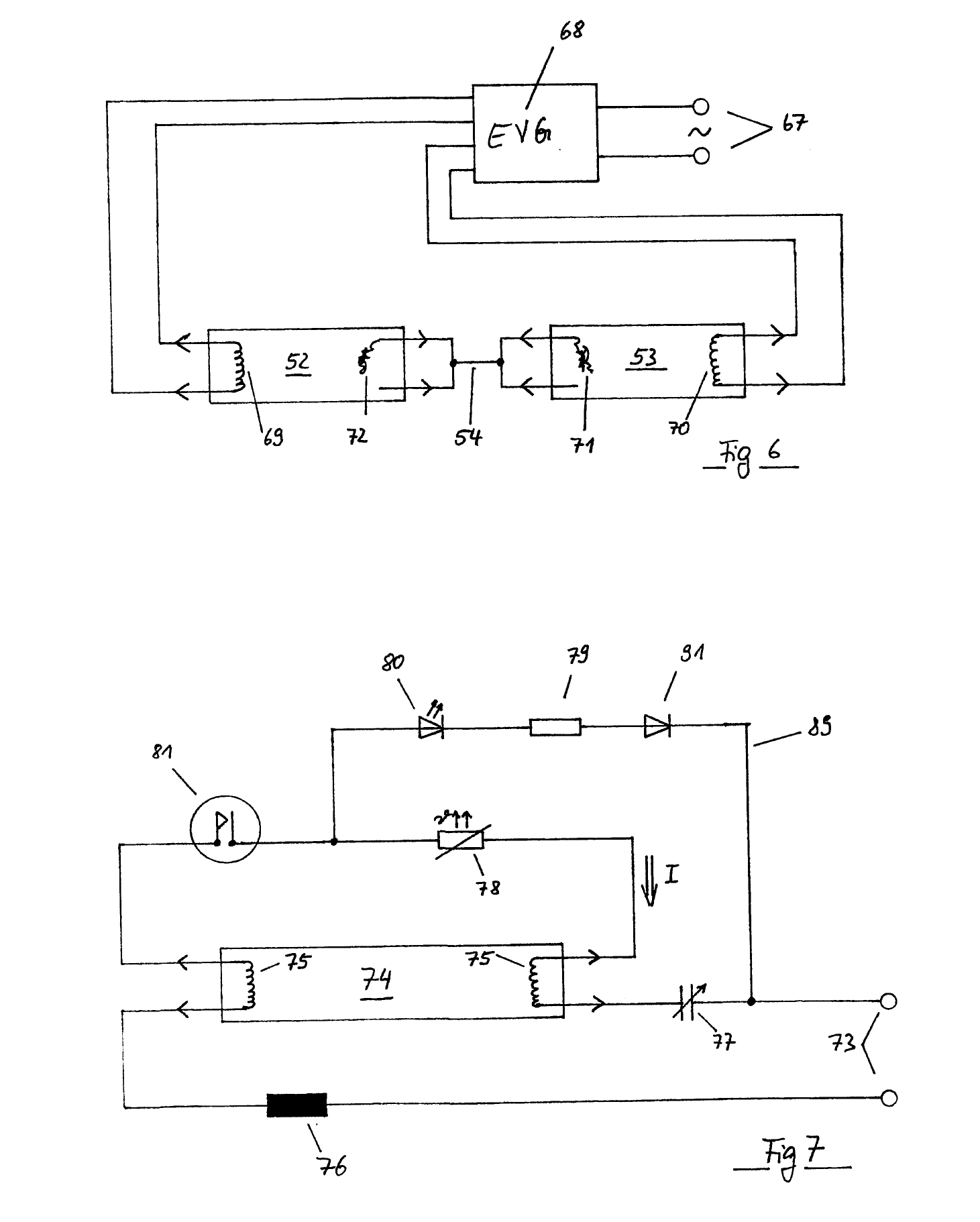

FIG. 6 a fluorescent lamp circuit comprising a series connection device;

FIG. 7 a fluorescent lamp circuit comprising a continuous-current protective circuit, a power-limiting circuit, as well as a visual monitoring device;

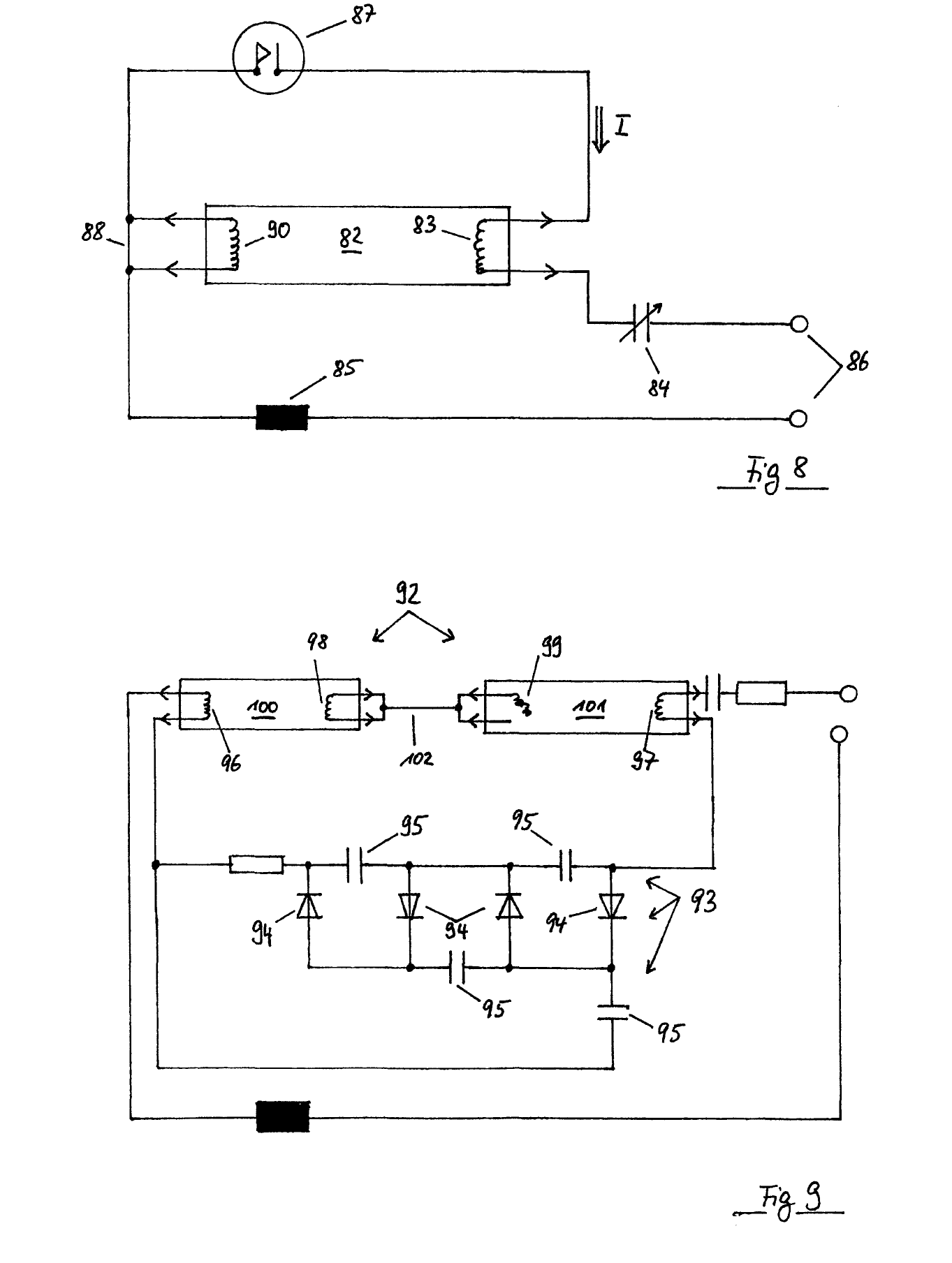

FIG. 8 a fluorescent lamp circuit comprising a power-limiting device as well as a bypass circuit in which a fully functional fluorescent lamp is used; and

FIG. 9 a fluorescent lamp circuit comprising a series connection device and a voltage booster device.

FIG. 1 shows a largely conventional individual circuit for fluorescent lamps. At its opposite ends, the fluorescent lamp 1 comprises an oxide electrode 2, 3 each. By means of a heating current I which flows through the heating current circuit 11, the oxide electrodes 2, 3 can be heated up to a temperature which is suitable for emitting electrons.

Immediately after switching on, i.e. after an alternating voltage, for example the usual mains voltage of 230 V/50 Hz (e.g. in Europe) or 110 V/60 Hz (e.g. in the USA) has been applied to the connections 10, first the glow discharge lamp 5 which serves as a starter ignites. Due to the glow discharge in the glow discharge lamp 5 the glow discharge lamp electrodes which are designed as bimetal electrodes 6 bend to the extent that they touch each other. After this, a very strong heating current I flows through the heating current circuit 11 which heats the oxide electrodes 2, 3 to a temperature which is suitable for emitting electrons. In the glow discharge lamp 5, which then cools down again, the two bimodal electrodes 6 return to their initial position, thus interrupting the heating current I. This abrupt interruption of the heating current I causes high tension as a result of self induction in the lamp ballast 4, said high tension igniting the fluorescent lamp. After the gas discharge in the fluorescent lamp I has ignited, the latter essentially acts as a short circuit, wherein the current flowing through the fluorescent lamp is limited by the lamp ballast 4 which acts as reactive impedance.

However, if for whatever reason the fluorescent lamp I fails to ignite, the glow discharge lamp 5 ignites again, after which a strong heating current I again flows through the heating current circuit 11 which again heats up the oxide electrodes 2, 3. In a conventional individual circuit, this procedure would continually repeat itself, which would cause significant wear in the oxide electrodes 2, 3. In order to prevent this, in the present circuit a continuous-current protective circuit 13 is looped into the heating circuit 11. The continuous-current protective circuit 13 comprises two branches 14, 15 connected in parallel. The first branch 14 comprises a PTC resistor (positive temperature coefficient). In the second branch 15 a PTC resistor 8 and a capacitor 9 are connected in series. Should the fluorescent lamp 1 fail to ignite, then the heating current I causes the PTC resistor 7 to heat up. This heating up generates an increase in resistance in the branch 14 of the continuous-current protective device 13 which leads to a reduction of the heating current I in the heating current circuit 11. As a result of the reduction of the heating current I in the heating current circuit 11, the wear in oxide electrodes 2, 3 in the case of a fluorescent lamp I failing to ignite is significantly reduced.

The capacitor 9 is selected so that even when the glow discharge lamp 5 is shorted out, essentially no current flows through the second branch 15.

Consequently, the PTC resistor 8 does not significantly heat up, i.e. it continues to be conductive. If there is a very brief power failure when the oxide electrodes 2, 3 are still hot, a current can flow via the second branch 15, with said current, while not being adequate for effective heating of the two oxide electrodes 2, 3, being nevertheless powerful enough to allow ignition of the fluorescent lamp I if the glow discharge lamp 5 is functional.

Of course other circuit-technology measures are also imaginable which in the case of a fluorescent lamp 1 failing to ignite, reduce or totally interrupt a continuous heating current I in the heating current circuit 11.

FIG. 2 shows an example of a fluorescent lamp circuit which comprises a bypass circuit. At the first end the fluorescent lamp 16 comprises a functional oxide electrode 18, and at the second end which is opposite the first end it comprises a defective oxide electrode 17. In the defective oxide electrode 17, the electrode wire has burnt out in one position so that the electrical connection between the two connecting pins at the second end of the fluorescent lamp 16 is interrupted. In the bypass circuit the two connecting pins 19 on the second end of the fluorescent lamp 16 are shorted out by a connecting cable 20, which is arranged outside the fluorescent lamp. In spite of the defective oxide electrode 17, the heating current circuit 21 is thus closed via the bridging cable 20, so that a heating current I can flow through the heating current circuit 21. Furthermore, the heating current circuit 21 leads through a lamp ballast 22, through an electronic starter 23 as well as through the functional oxide electrode 18. Immediately after switching on, i.e. after an alternating voltage has been connected to the connection terminals 24, first a strong heating current I flows through the heating current circuit 21, thus heating the functional oxide electrode 18 to a temperature which is adequate for emitting electrons. After a brief period, this temperature is reached and the electronic starter 23 generates a high ignition voltage between the functional oxide electrode 18 and the defective oxide electrode 17. In this process, the polarity of the voltage is important. Since only the functional oxide electrode 18 generates a temperature which is adequate for emitting electrons, the negative polarity must be present at the functional oxide electrode 18, while the positive polarity is present at the defective oxide electrode 17. The fluorescent lamp 16 now ignites and starts to light up. Thereafter, the electronic starter 23 switches the heating current I off. For a while after ignition, electrons emanate in the direction of the arrow e& only. However, after some time in operation, the defective oxide electrode 17 can heat up as a result of dissipation heat to the extent that its temperature is also adequate for emitting electrons.

The circuit arrangement shown in FIG. 2 makes it possible to continue the use of fluorescent lamps which previously were deemed to be defective, namely where the oxide electrode at one end of the fluorescent lamp is burnt out. In an improvement (not shown in detail) of the circuit arrangement shown in FIG. 2, at both ends of the fluorescent lamp 16 a switchable bridging cable is provided, wherein the switchable bridging cables are switched by an automatic control system such that there is automatic detection whether there is a defect in the oxide electrode, and if so at which end of the fluorescent lamp. This can for example take place by means of a continuity check. The automatic control system (not shown) then causes the switchable bridging cable to be closed at the respective end of the fluorescent lamp 16, and the electronic starter 23 to apply, with the correct polarity, the ignition voltage generated by said starter 23 to the fluorescent lamp 16.

FIG. 3 shows a fluorescent lamp circuit which comprises a continuous operation device. The heating current circuit 34 comprises a lamp ballast 29, a first oxide electrode 32, a glow discharge lamp starter 30 with a starter capacitor 3 1 connected in parallel to said glow discharge lamp starter 30, a second oxide electrode 32 of the fluorescent lamp 25, and a continuous operation activation device 26. As soon as the alternating voltage which is required for operation is applied to the connection terminals 35, the fluorescent lamp 25 ignites according to the description provided in the context of FIG. 1. Different from the circuit shown in FIG. 1, the present heating current circuit 34 comprises a continuous operation activation device 26 instead of a continuous-current protective device 13 (FIG. 1). In the present case, the continuous operation activation device 26 comprises two branches connected in parallel. The first branch comprises a current-limiting device which in the present embodiment is an adjustable capacitor 27. The second branch of the continuous operation activation device 26, which is switched parallel to the first branch, comprises a switch 28. If the switch 28 is in its closed position, as shown, then the fluorescent lamp 25 is essentially operated at the rated power of the fluorescent lamp 25. Thus the fluorescent lamp lights with maximum brightness. Instead of switching off the fluorescent lamp, for example by disconnecting the mains voltage, the switch 28 is opened so that the fluorescent lamp is subsequently in a dimmed position. Due to the adjustable capacitor 27, a reduced current now flows through the gas discharge ignited in the fluorescent lamp 25, so that the fluorescent lamp 25 now only lights at reduced brightness. For example 0.1 W is a suitable power value for the dimmed position. By means of the adjustable capacitor, during installation, the lamp can be set individually to the desired residual power or to the desired residual brightness in the dimmed position. The value of the capacitor depends on the form, design, length and thickness of the fluorescent lamp 25 used.

Such continuous operation in a dimmed position makes sense, for example, in stairwells and corridors. When the time period set on a timer has expired, the stairwell lighting is not completely switched off but instead changes to a dimmed state. In this way, anyone still present in the stairwell is still able to find their way around. Furthermore, the circuit shown in FIG. 3 largely operates without the need for switching the fluorescent lamp 25 on and off, so that a heating current I has to be applied to the oxide electrodes 32, 33 considerably less frequently. Consequently the service life of the fluorescent lamp can be significantly prolonged.

Of course it is also possible for the stairwell circuit to dim the light during normal office hours while switching the light off completely during the night and on weekends, so as to save energy. Since a glow discharge lamp starter 30 is still present, initial ignition of the fluorescent lamp in the morning of each working day or after power failure is possible without any problems.

FIG. 4 shows a fluorescent lamp circuit comprising an additional heating device. In the present circuit the heating current circuit 39, through which a heating current I flows during the switch-on procedure, comprises a lamp ballast 45, a first oxide electrode 37, an electronic starter 44, a second oxide electrode 38 as well as a PTC resistor 43. A second branch 41 comprising a capacitor 42 is connected in parallel to the PTC resistor 43. The capacitor 42 serves to enable a minimum current flow, so that the fluorescent lamp can ignite.

In the PTC resistor 43, electrical energy is converted to heat energy. The heat generated in said PTC resistor 43 is used to additionally heat up the oxide electrodes 37 and 38. PTC resistor 43 and oxide electrodes 37, 38 are matched so that the oxide electrodes 37 and 38 are subjected to as little load as possible. After the temperature necessary for the oxide electrodes 37 and 38 to emit electrons has been reached, the electronic starter 44 applies an ignition voltage to the two oxide electrodes 37, 38, so that a gas discharge in the fluorescent lamp 36 is ignited.

In the example shown in FIG. 4, a curved fluorescent lamp 36 is used, as it is used for example for so-called power-saving lamps or for street lamps. As shown in FIG. 4, due to the curved shape it is possible for a single PTC resistor 43, which generates additional heat, to heat up both oxide electrodes 37, 38. Of course, correspondingly matched circuits for fluorescent lamps of elongated shape are also imaginable.

While FIGS. 1 to 4 described above show a selection of implementation options of the invention individually, the fluorescent lamp circuit depicted in FIG. 5 shows a combination of several implementation options of the present invention, which options mutually complement each other in a sensible way.

The circuit shown in FIG. 5 comprises a bypass circuit 51, a voltage doubler circuit 55 which at the same time is an electronic igniter, as well as a continuous operation activation device 56. By way of the bright-dark switch 61 of the continuous operation activation device 56, the fluorescent lamp 47 can be switched between a bright and a dimmed position. In addition, a mains switch 57 is provided with which the fluorescent lamp 47 can be switched off completely.

The voltage doubler circuit 55 essentially comprises a bridge-connected rectifier 64 as well as two capacitors 65, 66. In addition, in each instance a PTC resistor 62, 63 is connected in series to the capacitors 65, 66. During the switch-on procedure of the fluorescent lamp 47 the PTC resistors 62, 63 are still cold so that they do not influence the capacitors 65, 66. There is thus a doubling of the voltage flowing through assembly 55. After the circuit has been in operation for some time, the PTC resistors 62, 63 heat up, so that their resistance increases and the voltage increase is reduced. In this way flickering of the fluorescent lamp 47 is reduced.

By means of the bypass circuit 51, the fluorescent lamp 47 is ignited at both ends of the fluorescent lamp 47, without either of the electrodes 48, 49 being electrically heated prior to ignition. Thus, ignition and operation of the fluorescent lamp 47 are only possible due to the voltage boost by the voltage doubler circuit 55. The bypass circuit 51 is made such that at both ends of the fluorescent lamp 47 the respective connecting pins of the two oxide electrodes 48, 49, are electrically interconnected by a bridge 50. The design shown makes it possible to continue using fluorescent lamps 47 where both oxide electrode 47, 48 are defective. In this case, it makes sense, as a rule, to operate the fluorescent lamp at a power which is reduced when compared with the normal rated power, so that the residual service life of the fluorescent lamp is still adequate.

Of course the circuit described can be altered such that prior to ignition of the fluorescent lamp 47, heating of the oxide electrodes 48 and 49 takes place. Such heating can take place either by way of the oxide electrodes 48, 49 themselves, provided they are not defective, or by way of additional heating elements.

FIG. 6 shows a fluorescent lamp circuit in which two fluorescent lamps 52, 53 are connected in series. In known series connections of fluorescent lamps, prior to ignition, a heating current is applied to all oxide electrodes of the fluorescent lamps used. In contrast, in the embodiment according to the invention shown in FIG. 6, only the two outermost oxide electrodes 69, 70 are heated up. Applying a heating current as well as generating an ignition voltage is controlled by a commercially available electronic series ballast 68 which is connected to a mains voltage by way of connection terminals 67. This is to point out expressly that the electronic series ballast 68 is a commercially available electronic series ballast which does not require any modification. In contrast, no heating current is applied to the inner oxide electrodes 71, 72, which are electrically interconnected by a connecting cable 54. FIG. 6 shows the two inner oxide electrodes 71, 72, each with a defect. Again, with this circuit, fluorescent lamps can be used in which the oxide electrodes at one end of the fluorescent lamp are damaged. Of course it is also possible to use fully functional fluorescent lamps in connection with the circuit shown.

It should be pointed out that the total length of the fluorescent lamps 52, 53 shown in FIG. 6 approximately corresponds to the length of a fluorescent lamp to be used with the electronic series ballast 68. Thus, if the electronic series ballast 68 is for example designed for operating fluorescent lamps 1,200 mm in length, then the length of the fluorescent lamps 52, 53 can be 600 mm each.

FIG. 7 shows a further fluorescent lamp circuit. A controllable capacitor 77 serves as a power-limiting device with which the power of the fluorescent lamp 74 in operation can be reduced in relation to the rated power of the fluorescent lamp. By this measure alone, the service life of the fluorescent lamp can be prolonged. If the fluorescent lamp is for example operated at a maximum power of 75% of the rated power, then, as a rule, the service life of the fluorescent lamp 74 is prolonged by a factor of three. Due to the fact that the adjustable capacitor 77 is adjustable, furthermore the brightness of the fluorescent lamp 74 can be dimmed so that there is no need to use an expensive dimmer suitable for fluorescent lamps.

Ignition of the fluorescent lamp 74 shown in FIG. 7 takes place after the two oxide electrodes 75 have been heated up by a heating current I, wherein, as has already been described, the ignition voltage is generated by a glow discharge lamp starter 81 and a lamp ballast 76. In addition, the circuit shown comprises a continuous-current protective circuit in the form of a PTC resistor 78. In addition, the circuit comprises a light-emitting diode circuit 89 comprising a light-emitting diode 80 and an associated protective resistor 79 as well as an additional diode 91.

If the glow discharge lamp starter 81 is defective, so that at first the heating current I stops, then the PTC resistor 78 heats up. Due to the associated voltage drop, the voltage present at the two ends of the light-emitting diode circuit 89 is adequate for the light-emitting diode 80 to light up. The light-emitting diode 80 thus serves as a visual monitoring device which displays a defect in the glow discharge lamp starter 81.

FIG. 8 depicts an example which shows that the invention can also be used in conjunction with fluorescent lamps 82 in which both oxide electrodes 83, 90 are still fully functional. In the example shown, the fluorescent lamp circuit shows the normal components, namely lamp ballast 85 and glow discharge lamp starter 87, as well as an adjustable capacitor 84 which is used as an adjustable power-limiting device, as well as a bridge 88 which serves as a bypass circuit. When compared with a known fluorescent lamp circuit, a first oxide electrode 83 experiences slightly reduced wear because of the power-limiting circuit. In contrast, due to the bypass circuit, a second oxide electrode 90 experiences almost no wear. If the first oxide electrode 83 becomes defective, due to wear, then the fluorescent lamp can continue to be used after being turned around in the circuit shown.

FIG. 9 shows a fluorescent lamp circuit comprising a combination of a series connection device 92 and a voltage booster device 93. The voltage booster device 93 is designed as a voltage multiplier cascade, made from a multiple number of diodes 94 as well as cascade capacitors 95. Since the voltage booster device 93 supplies a higher voltage to the external oxide electrodes 96, 97 of the series connection device 92, which in the present example comprises two fluorescent lamps 100, 101, there is no need to provide a separate quick-starter. The interior oxide electrodes 98, 99 of the fluorescent lamps 100, 101 are interconnected via a connecting cable 102 in such a way that contact is established between the four connecting pins of the interior oxide electrodes 98, 99. In the present example, only the oxide electrode 99 is defective. However, the circuit makes it possible to operate the fluorescent lamps 100, 101 also if only the oxide electrode 98 is defective, or if both oxide electrodes 98, 99 are defective, or even if both oxide electrodes 98, 99 are functional.

Of course, any other combinations of the various embodiments of the invention are imaginable. Depending on the application, these can provide specific advantages.

1. A method for operating fluorescent lamps (1, 16, 25, 36, 47, 52, 53, 74, 82), in particular for prolonging the service life of fluorescent lamps,
characterized in that
the load of at least parts of at least one electrode device (2, 3, 17, 18, 32, 33, 37, 38, 48, 49, 71, 72, 75, 90) of at least one fluorescent lamp is reduced by applying an electrical current, in particular a heating current (I), by means of a reduction in the load over time, and/or a reduction in the electrical power.

2. The method according to claim 1,
characterized in that
a heating current (I) is applied in at least one fluorescent lamp (16, 52, 53, 82) at most at one end of the fluorescent lamp to at least parts of the electrode device (17, 18, 69, 70, 83) located there.

3. The method according to claim 1 or 2,
characterized in that
the power of the heating current (I) of at least a part of at least one electrode device (2, 3, 75) of at least one fluorescent lamp (1, 74) is at least reduced after a period of time, in particular when an ignition device (5, 81) is defective.

4. The method according to one of the preceding claims,
characterized in that
ignition and/or operation of at least one fluorescent lamp (47) take/s place at an increased voltage, when compared with the supply voltage of the fluorescent lamp circuit, at the electrode devices (48, 49) of the fluorescent lamp.

5. The method according to claim 4,
characterized in that
the voltage at the electrode devices (48, 49) of at least one fluorescent lamp (47) during ignition and/or during operation is at least 400 V, preferably at least 600 V.

6. The method according to any one of the preceding claims,
characterized in that
at least one fluorescent lamp (1, 16, 25, 36, 47, 74, 82) is operated at a power which is reduced when compared with the rated power of the fluorescent lamp.

7. The method according to any one of the preceding claims,
characterized in that
at least one fluorescent lamp (47) is essentially operated in continuous operation, wherein there is alteration at least between a dimmed position with reduced power of the fluorescent lamp, and a bright position, in particular a position with essentially full power of the fluorescent lamp.

8. The method according to claim 7,
characterized in that
the power of the fluorescent lamp (47) in the dimmed position is 0.1% to 20% of the power in the bright position.

9. The method according to any one of the preceding claims,
characterized in that
reduction in the power of at least one fluorescent lamp (74, 82) is achieved by passive, essentially non-dissipative components (77, 84), such as, in particular, controllable capacitors and controllable coils.

10. The method according to any one of the preceding claims,
characterized in that
in at least one fluorescent lamp (36) additional application of heat (43) to at least a part of at least one electrode device (38) takes place.

11. The method according to claim 10,
characterized in that
the additional application of heat is by a component (43, 54) which is independent of the fluorescent lamp (36, 47).

12. The method according to claim 10 or 11,
characterized in that
the additional application of heat takes place immediately before the ignition procedure and/or during the ignition procedure of the fluorescent lamps (36).

13. The method according to any one of the preceding claims, in particular claim 3,
characterized in that
status information (80) about the operational state of the fluorescent lamp circuit, in particular status information about defects that occur, is issued.

14. The method according to claim 13,
characterized in that
the status information is issued visually, in particular by means of light emission (80).

15. The method according to one of the preceding claims,
characterized in that
several fluorescent lamps (52, 53) are connected in series, wherein in the series connection comprising fluorescent lamps, heating current is applied only to a part of the electrode devices (69, 70) of the fluorescent lamps, in particular only to the two outermost electrode devices of the series connection.

16. The use of the method according to any one of claims 1 to 15, in particular the method according to any one of claims 2, 4, 5, 10, 11, 12 or 15, in conjunction with fluorescent lamps (16, 47, 52, 53) in which at least parts of the electrode device (17, 48, 71, 72) at least at one end of the fluorescent lamp are defective.

17. A fluorescent lamp circuit for operating fluorescent lamps, in particular for implementing the method according to any one of claims 1 to 15,
characterized in that
the fluorescent lamp circuit comprises at least one current-limiting device (13, 20, 26, 43, 51, 52, 55, 56, 77, 78, 88, 84) which limits the electrical current, in particular the heating current (I), through at least parts of at least one electrode device (2, 3, 17, 18, 32, 33, 37, 38, 48, 49, 71, 72, 75, 83, 90) of at least one fluorescent lamp (1, 16, 25, 36, 47), concerning the electrical power and/or the duration of time.

18. The fluorescent lamp circuit according to claim 17,
characterized in that
at least one current-limiting device is designed as a continuous-current protective circuit (13, 78), such that the heating current (I) through at least parts of at least one electrode device (2, 3, 75) of at least one fluorescent lamp (1, 74) after a period of time, in particular during a defect of the ignition device (5, 81) of the fluorescent lamp, is at least reduced.

19. The fluorescent lamp circuit according to claim 18,
characterized in that
at least one continuous-current protective circuit (13, 78) comprises at least one temperature-sensitive resistor device (7, 8, 78), in particular a temperature-sensitive resistor device whose electrical resistance increases as the temperature rises.

20. The fluorescent lamp circuit according to any one of claims 17 to 19,
characterized in that
at least one current-limiting device is designed as a bypass circuit (20, 5 1, 88), such that a heating current (I) is applied to at least one fluorescent lamp (16, 47, 82) at most at one end of the fluorescent lamp, at least to parts of the electrode device (18, 49, 83) located there.

21. The fluorescent lamp circuit according to claim 20,
characterized in that
at least one bypass circuit comprises an electrical connection (20, 50, 88) of contacts (19) of the electrode device (17, 48, 90), in particular a short circuit of the contacts, on at least one end of at least one fluorescent lamp (1, 47, 82).

22. The fluorescent lamp circuit according to claim 20 or 21,
characterized in that
at least one bypass circuit is designed as an automatically detecting bypass circuit, such that the automatically detecting bypass circuit, during a defect of at least parts of the electrode device which is located at one end of at least one fluorescent lamp, automatically activates the electrode device at the corresponding end of the fluorescent lamp.

23. The fluorescent lamp circuit according to any one of claims 17 to 22,
characterized in that
at least one current-limiting device is designed as a voltage booster device (55), such that the ignition procedure and/or the operation of at least one fluorescent lamp (47) take/s place at a voltage which is increased in comparison with the supply voltage.

24. The fluorescent lamp circuit according to claim 23,
characterized in that
at least one voltage booster device comprises at least one voltage multiplier circuit (55).

25. The fluorescent lamp circuit according to any one of claims 17 to 24,
characterized in that
at least one current-limiting device comprises at least one additional heating device (43, 54), which in at least one fluorescent lamp (36, 47) applies heat to at least parts of at least one electrode device (38, 49).

26. The fluorescent lamp circuit according to claim 25,
characterized in that
in at least one fluorescent lamp (36, 47) at least parts of at least one additional heating device (43, 54) are designed so as to be independent of the fluorescent lamp.

27. The fluorescent lamp circuit according to claim 25 or 26,
characterized in that
at least one additional heating device of at least one fluorescent lamp (36, 47) comprises at least one temperature-dependent resistor device (43, 54), in particular a temperature-dependent resistor device whose electrical resistance increases as the temperature rises.

28. The fluorescent lamp circuit according to any one of claims 25 to 27,
characterized in that
at least parts of at least one additional heating device (43, 54) of at least one fluorescent lamp (36, 47) are connected in series with at least parts of at least one electrode device (37, 38, 49) of at least one fluorescent lamp.

29. The fluorescent lamp circuit according to any one of claims 17 to 28,
characterized in that
at least one current-limiting device is designed as a power-limiting device (77, 84), in particular as a controllable power-limiting device, such that at least one fluorescent lamp is operated at a power which is lower than the rated power of the fluorescent lamp.

30. The fluorescent lamp circuit according to claim 29,
characterized in that
at least one power-limiting device essentially comprises passive, essentially non-dissipative components, such as in particular regulatable capacitors (77, 84) and/or regulatable coils.

31. The fluorescent lamp circuit according to any one of claims 17 to 30,
characterized in that
at least one current-limiting device is designed as a continuous operation device (26, 56), such that at least one fluorescent lamp (25, 47) is essentially operated in continuous operation, wherein the fluorescent lamp alternates at least between a dimmed position with low power and a bright position, in particular a position with essentially full power.

32. The fluorescent lamp circuit according to claim 31,
characterized in that
the continuous operation device (26, 56) is made such that the power of the fluorescent lamp (25, 47) in the dimmed position is 0.1% to 20% of the power in the bright position.

33. The fluorescent lamp circuit according to any one of claims 17 to 32,
characterized in that
at least one current-limiting device is designed as a series connection device, such that several fluorescent lamps (52, 53) are connected in series, wherein in the series connection comprising fluorescent lamps a heating current is applied only to a part of the electrode devices (69, 70), in particular only to the two outermost electrode devices of the series connection.

34. The fluorescent lamp circuit according to any one of claims 17 to 33,
characterized in that
the fluorescent lamp circuit comprises at least one monitoring device (80), such that the status of the fluorescent lamp circuit, and in particular a malfunction thereof, is displayed.

35. The fluorescent lamp circuit according to claim 34,
characterized in that
the monitoring device is a visual device (80).

36. The fluorescent lamp circuit according to claim 34 or 35,
characterized in that
the visual device is designed as a light emitting device, in particular an incandescent lamp and/or a light emitting diode (80).
